(19) United States
(12) Patent Application Publication
(10) Pub. No.: US 2018/0052736 A1
(43) Pub. Date: Feb. 22, 2018

(54) INITIALIZING STORAGE UNIT PERFORMANCE RANKINGS IN NEW COMPUTING DEVICES OF A DISPERSED STORAGE NETWORK

(71) Applicant: International Business Machines Corporation, Armonk, NY (US)

(72) Inventors: Ilir Iljazi, Chicago, IL (US); Jason K. Resch, Chicago, IL (US)

(21) Appl. No.: 15/240,488

(22) Filed: Aug. 18, 2016

(51) Int. Cl. G06F 11/10; G06F 3/06

(52) U.S. Cl. CPC G06F 11/1092; G06F 11/1096; G06F 3/0665; G06F 3/0619; G06F 3/0689

(57) ABSTRACT

Methods for use in a dispersed storage network (DSN) to enable sharing of storage unit performance ranking information between computing devices. In one example, a new computing device of the DSN requests performance ranking information from one or more established computing devices, or from a database of such information that is curated by the DSN. After receiving and storing such information, the new computing device utilizes it to select one or more storage units/sets of storage units for performing dispersed storage operations (e.g., retrieval or storage of dispersed storage error encoded data). The computing device may then update the stored performance ranking information with information regarding such dispersed storage operations, and subsequently share the updated performance ranking information with other computing devices of the DSN and/or a database maintained by the DSN.

### STATEMENT REGARDING FEDERALLY SPONSORED RESEARCH OR DEVELOPMENT

Not applicable.

### INCORPORATION-BY-REFERENCE OF MATERIAL SUBMITTED ON A COMPACT DISC

Not applicable.

### BACKGROUND OF THE INVENTION

### Technical Field of the Invention

This invention relates generally to computer networks, and more particularly to sharing of storage unit performance ranking information in a dispersed storage network.

### Description of Related Art

Computing devices are known to communicate data, process data, and/or store data. Such computing devices range from wireless smart phones, laptops, tablets, personal computers (PC), work stations, and video game devices, to data centers that support millions of web searches, stock trades, or on-line purchases every day. In general, a computing device includes a central processing unit (CPU), a memory system, user input/output interfaces, peripheral device interfaces, and an interconnecting bus structure.

As is further known, a computer may effectively extend its CPU by using “cloud computing” to perform one or more computing functions (e.g., a service, an application, an algorithm, an arithmetic logic function, etc.) on behalf of the computer. Further, for large services, applications, and/or functions, cloud computing may be performed by multiple cloud computing resources in a distributed manner to improve the response time for completion of the service, application, and/or function. For example, Hadoop is an open source software framework that supports distributed applications enabling application execution by thousands of computers.

In addition to cloud computing, a computer may use “cloud storage” as part of its memory system. As is known, cloud storage enables a user, via its computer, to store files, applications, etc. on a remote storage system. The remote storage system may include a RAID (redundant array of independent disks) system and/or a dispersed storage system that uses an error correction scheme to encode data for storage.

In a RAID system, a RAID controller adds parity data to the original data before storing it across an array of disks. The parity data is calculated from the original data such that the failure of a single disk typically will not result in the loss of the original data. While RAID systems can address certain memory device failures, these systems may suffer from effectiveness, efficiency and security issues. For instance, as more disks are added to the array, the probability of a disk failure rises, which may increase maintenance costs. When a disk fails, for example, it needs to be manually replaced before another disk(s) fails and the data stored in the RAID system is lost. To reduce the risk of data loss, data on a RAID device is often copied to one or more other RAID devices. While this may reduce the possibility of data loss, it also raises security issues since multiple copies of data may be available, thereby increasing the chances of unauthorized access. In addition, co-location of some RAID devices may result in a risk of a complete data loss in the event of a natural disaster, fire, power surge/outage, etc.

### BRIEF DESCRIPTION OF THE SEVERAL VIEWS OF THE DRAWING(S)

FIG. 1 is a schematic block diagram of an embodiment of a dispersed, or distributed, storage network (DSN) in accordance with the present disclosure;

FIG. 2 is a schematic block diagram of an embodiment of a computing core in accordance with the present disclosure;

FIG. 3 is a schematic block diagram of an example of dispersed storage error encoding of data in accordance with the present disclosure;

FIG. 4 is a schematic block diagram of a generic example of an error encoding function in accordance with the present disclosure;

FIG. 5 is a schematic block diagram of a specific example of an error encoding function in accordance with the present disclosure;

FIG. 6 is a schematic block diagram of an example of slice naming information for an encoded data slice (EDS) in accordance with the present disclosure;

FIG. 7 is a schematic block diagram of an example of dispersed storage error decoding of data in accordance with the present disclosure;

FIG. 8 is a schematic block diagram of a generic example of an error decoding function in accordance with the present disclosure;

FIG. 9 is a schematic block diagram of an embodiment of a DSN including storage unit performance ranking information sharing in accordance with the present disclosure;

FIG. 10 is a logic diagram of exemplary use of storage unit performance ranking information in a newly-initialized computing device in accordance with the present disclosure; and

FIG. 11 is a logic diagram of an example of generation of storage unit performance ranking information in accordance with the present disclosure.

### DETAILED DESCRIPTION OF THE INVENTION

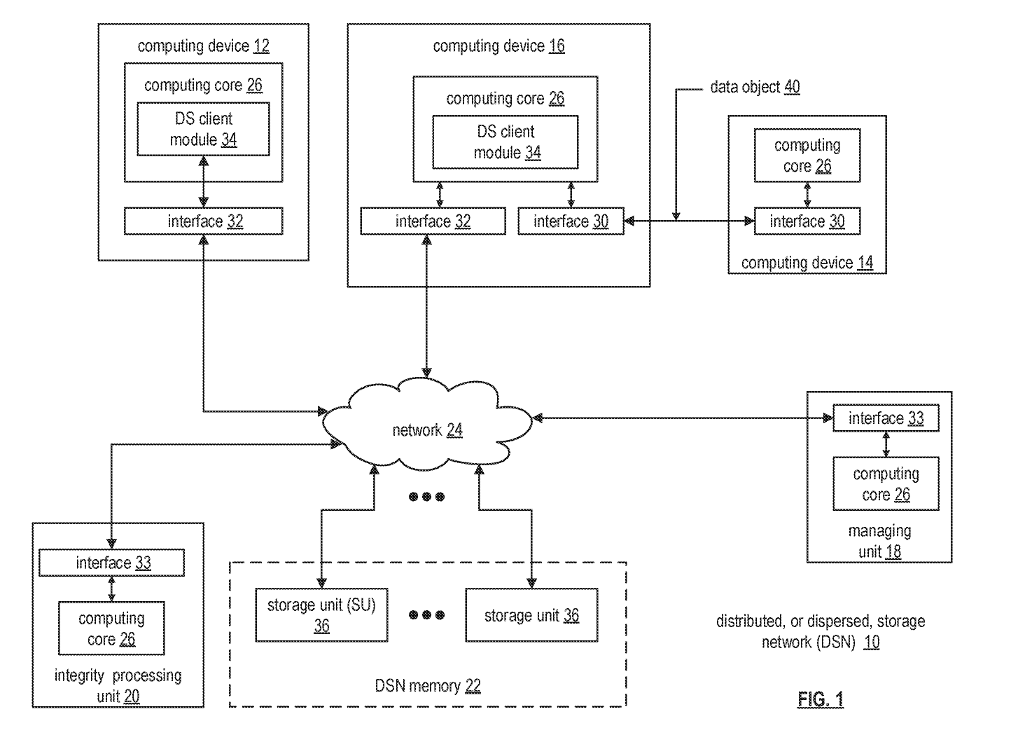

FIG. 1 is a schematic block diagram of an embodiment of a dispersed, or distributed, storage network (DSN) 10 that includes a plurality of computing devices 12-16, a managing unit 18, an integrity processing unit 20, and a DSN memory 22. The components of the DSN 10 are coupled to a network 24, which may include one or more wireless and/or wire lined communication systems; one or more non-public intranet systems and/or public internet systems; and/or one or more local area networks (LAN) and/or wide area networks (WAN).

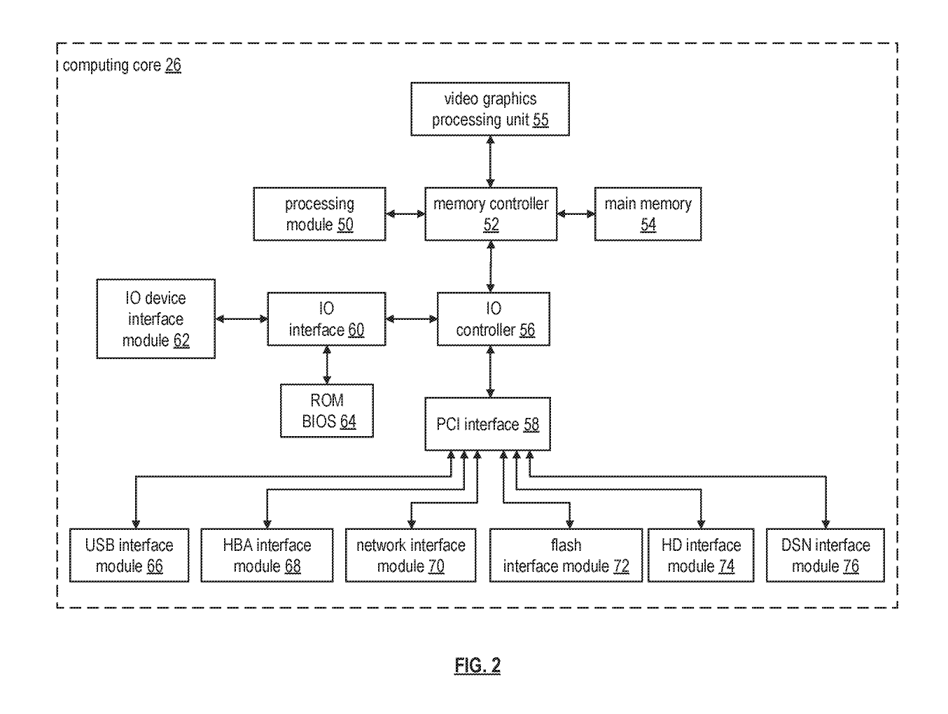

The DSN memory 22 includes a plurality of storage units 36 that may be located at geographically different sites (e.g., one in Chicago, one in Milwaukee, etc.), at a common site, or a combination thereof. For example, if the DSN memory 22 includes eight storage units 36, each storage unit is located at a different site. As another example, if the DSN memory 22 includes eight storage units 36, all eight storage units are located at the same site. As yet another example, if the DSN memory 22 includes eight storage units 36, a first pair of storage units are at a first common site, a second pair of storage units are at a second common site, a third pair of storage units are at a third common site, and a fourth pair of storage units are at a fourth common site. Note that a DSN memory 22 may include more or less than eight storage units 36. Further note that each storage unit 36 includes a computing core (as shown in FIG. 2, or components thereof) and a plurality of memory devices for storing dispersed storage error encoded data.

Each of the computing devices 12-16, the managing unit 18, and the integrity processing unit 20 include a computing core 26, which includes network interfaces 30-33. Computing devices 12-16 may each be a portable computing device and/or a fixed computing device. A portable computing device may be a social networking device, a gaming device, a cell phone, a smart phone, a digital assistant, a digital music player, a digital video player, a laptop computer, a handheld computer, a tablet, a video game controller, and/or any other portable device that includes a computing core. A fixed computing device may be a computer (PC), a computer server, a cable set-top box, a satellite receiver, a television set, a printer, a fax machine, home entertainment equipment, a video game console, and/or any type of home or office computing equipment. Note that each of the managing unit 18 and the integrity processing unit 20 may be separate computing devices, may be a common computing device, and/or may be integrated into one or more of the computing devices 12-16 and/or into one or more of the storage units 36.

Each interface 30, 32, and 33 includes software and hardware to support one or more communication links via the network 24 indirectly and/or directly. For example, interface 30 supports a communication link (e.g., wired, wireless, direct, via a LAN, via the network 24, etc.) between computing devices 14 and 16. As another example, interface 32 supports communication links (e.g., a wired connection, a wireless connection, a LAN connection, and/or any other type of connection to/from the network 24) between computing devices 12 and 16 and the DSN memory 22. As yet another example, interface 33 supports a communication link for each of the managing unit 18 and the integrity processing unit 20 to the network 24.

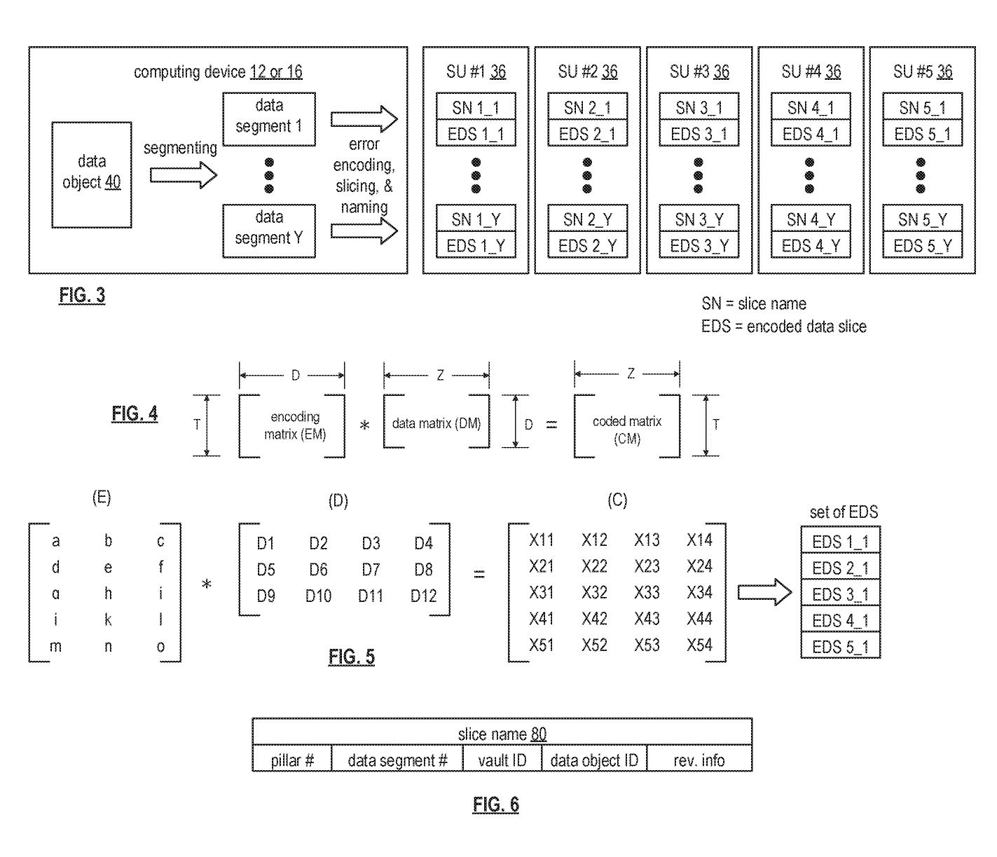

Computing devices 12 and 16 include a dispersed storage (DS) client module 34, which enables the computing device to dispersed storage error encode and decode data (e.g., data object 40) as subsequently described with reference to one or more of FIGS. 3-8. In this example embodiment, computing device 16 functions as a dispersed storage processing agent for computing device 14. In this role, computing device 16 dispersed storage error encodes and decodes data on behalf of computing device 14. With the use of dispersed storage error encoding and decoding, the DSN 10 is tolerant of a significant number of storage unit failures (the number of failures is based on parameters of the dispersed storage error encoding function) without loss of data and without the need for a redundant or backup copies of the data. Further, the DSN 10 stores data for an indefinite period of time without data loss and in a secure manner (e.g., the system is very resistant to unauthorized attempts at accessing the data).

In operation, the managing unit 18 performs DS management services. For example, the managing unit 18 establishes distributed data storage parameters (e.g., vault creation, distributed storage parameters, security parameters, billing information, user profile information, etc.) for computing devices 12-14 individually or as part of a group of user devices. As a specific example, the managing unit 18 coordinates creation of a vault (e.g., a virtual memory block associated with a portion of an overall namespace of the DSN) within the DSN memory 22 for a user device, a group of devices, or for public access and establishes per vault dispersed storage (DS) error encoding parameters for a vault. The managing unit 18 facilitates storage of DS error encoding parameters for each vault by updating registry information of the DSN 10, where the registry information may be stored in the DSN memory 22, a computing device 12-16, the managing unit 18, and/or the integrity processing unit 20. The managing unit 18 may also maintain and/or coordinate creation of a storage unit performance ranking information database such as described more fully below in conjunction with FIGS. 9-11.

The managing unit 18 creates and stores user profile information (e.g., an access control list (ACL)) in local memory and/or within memory of the DSN memory 22. The user profile information includes authentication information, permissions, and/or the security parameters. The security parameters may include encryption/decryption scheme, one or more encryption keys, key generation scheme, and/or data encoding/decoding scheme.

The managing unit 18 creates billing information for a particular user, a user group, a vault access, public vault access, etc. For instance, the managing unit 18 tracks the number of times a user accesses a non-public vault and/or public vaults, which can be used to generate per-access billing information. In another instance, the managing unit 18 tracks the amount of data stored and/or retrieved by a user device and/or a user group, which can be used to generate per-data-amount billing information.

As another example, the managing unit 18 performs network operations, network administration, and/or network maintenance. Network operations includes authenticating user data allocation requests (e.g., read and/or write requests), managing creation of vaults, establishing authentication credentials for user devices, adding/deleting components (e.g., user devices, storage units, and/or computing devices with a DS client module 34) to/from the DSN 10, and/or establishing authentication credentials for the storage units 36. Network administration includes monitoring devices and/or units for failures, maintaining vault information, determining device and/or unit activation status, determining device and/or unit loading, and/or determining any other system level operation that affects the performance level of the DSN 10. Network maintenance includes facilitating replacing, upgrading, repairing, and/or expanding a device and/or unit of the DSN 10.

To support data storage integrity verification within the DSN 10, the integrity processing unit 20 (and/or other devices in the DSN 10) may perform rebuilding of ‘bad’ or missing encoded data slices. At a high level, the integrity processing unit 20 performs rebuilding by periodically attempting to retrieve/list encoded data slices, and/or slice names of the encoded data slices, from the DSN memory 22. Retrieved encoded slices are checked for errors due to data corruption, outdated versioning, etc. If a slice includes an error, it is flagged as a ‘bad’ or ‘corrupt’ slice. Encoded data slices that are not received and/or not listed may be flagged as missing slices. Bad and/or missing slices may be subsequently rebuilt using other retrieved encoded data slices that are deemed to be good slices in order to produce rebuilt slices. A multi-stage decoding process may be employed in certain circumstances to recover data even when the number of valid encoded data slices of a set of encoded data slices is less than a relevant decode threshold number. The rebuilt slices may then be written to DSN memory 22. Note that the integrity processing unit 20 may be a separate unit as shown, included in DSN memory 22, included in the computing device 16, and/or distributed among the storage units 36.

FIG. 2 is a schematic block diagram of an embodiment of a computing core 26 that includes a processing module 50, a memory controller 52, main memory 54, a video graphics processing unit 55, an input/output (IO) controller 56, a peripheral component interconnect (PCI) interface 58, an IO interface module 60, at least one IO device interface module 62, a read only memory (ROM) basic input output system (BIOS) 64, and one or more memory interface modules. The one or more memory interface module(s) includes one or more of a universal serial bus (USB) interface module 66, a host bus adapter (HBA) interface module 68, a network interface module 70, a flash interface module 72, a hard drive interface module 74, and a DSN interface module 76.

The DSN interface module 76 functions to mimic a conventional operating system (OS) file system interface (e.g., network file system (NFS), flash file system (FFS), disk file system (DFS), file transfer protocol (FTP), web-based distributed authoring and versioning (WebDAV), etc.) and/or a block memory interface (e.g., small computer system interface (SCSI), internet small computer system interface (iSCSI), etc.). The DSN interface module 76 and/or the network interface module 70 may function as one or more of the interface 30-33 of FIG. 1. Note that the 10 device interface module 62 and/or the memory interface modules 66-76 may be collectively or individually referred to as IO ports.

FIG. 3 is a schematic block diagram of an example of dispersed storage error encoding of data. When a computing device 12 or 16 has data to store it disperse storage error encodes the data in accordance with a dispersed storage error encoding process based on dispersed storage error encoding parameters. The dispersed storage error encoding parameters include an encoding function (e.g., information dispersal algorithm, Reed-Solomon, Cauchy Reed-Solomon, systematic encoding, non-systematic encoding, on-line codes, etc.), a data segmenting protocol (e.g., data segment size, fixed, variable, etc.), and per data segment encoding values. The per data segment encoding values include a total, or pillar width, number (T) of encoded data slices per encoding of a data segment (i.e., in a set of encoded data slices); a decode threshold number (D) of encoded data slices of a set of encoded data slices that are needed to recover the data segment; a read threshold number (R) of encoded data slices to indicate a number of encoded data slices per set to be read from storage for decoding of the data segment; and/or a write threshold number (W) to indicate a number of encoded data slices per set that must be accurately stored before the encoded data segment is deemed to have been properly stored. The dispersed storage error encoding parameters may further include slicing information (e.g., the number of encoded data slices that will be created for each data segment) and/or slice security information (e.g., per encoded data slice encryption, compression, integrity checksum, etc.).

In the present example, Cauchy Reed-Solomon has been selected as the encoding function (a generic example is shown in FIG. 4 and a specific example is shown in FIG. 5); the data segmenting protocol is to divide the data object into fixed sized data segments; and the per data segment encoding values include: a pillar width of 5, a decode threshold of 3, a read threshold of 4, and a write threshold of 4. In accordance with the data segmenting protocol, the computing device 12 or 16 divides the data (e.g., a file (e.g., text, video, audio, etc.), a data object, or other data arrangement) into a plurality of fixed sized data segments (e.g., 1 through Y of a fixed size in range of Kilo-bytes to Tera-bytes or more). The number of data segments created is dependent of the size of the data and the data segmenting protocol.

The computing device 12 or 16 then disperse storage error encodes a data segment using the selected encoding function (e.g., Cauchy Reed-Solomon) to produce a set of encoded data slices. FIG. 4 illustrates a generic Cauchy Reed-Solomon encoding function, which includes an encoding matrix (EM), a data matrix (DM), and a coded matrix (CM). The size of the encoding matrix (EM) is dependent on the pillar width number (T) and the decode threshold number (D) of selected per data segment encoding values. To produce the data matrix (DM), the data segment is divided into a plurality of data blocks and the data blocks are arranged into D number of rows with Z data blocks per row. Note that Z is a function of the number of data blocks created from the data segment and the decode threshold number (D). The coded matrix is produced by matrix multiplying the data matrix by the encoding matrix.

FIG. 5 illustrates a specific example of Cauchy Reed-Solomon encoding with a pillar number (T) of five and decode threshold number of three. In this example, a first data segment is divided into twelve data blocks (D1-D12). The coded matrix includes five rows of coded data blocks, where the first row of X11-X14 corresponds to a first encoded data slice (EDS 1_1), the second row of X21-X24 corresponds to a second encoded data slice (EDS 2_1), the third row of X31-X34 corresponds to a third encoded data slice (EDS 3_1), the fourth row of X41-X44 corresponds to a fourth encoded data slice (EDS 4_1), and the fifth row of X51-X54 corresponds to a fifth encoded data slice (EDS 5_1). Note that the second number of the EDS designation corresponds to the data segment number. In the illustrated example, the value X11=aD1+bD5+cD9, X12=aD2+bD6+cD10, . . . X53=mD3+nD7+oD11, and X54=mD4+nD8+oD12.

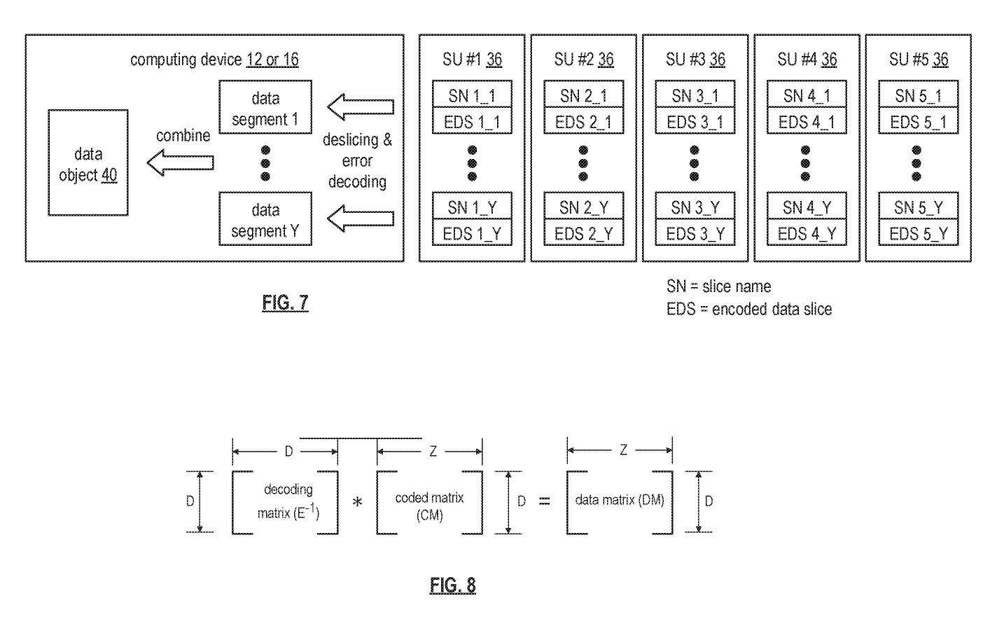

Returning to the discussion of FIG. 3, the computing device also creates a slice name (SN) for each encoded data slice (EDS) in the set of encoded data slices. A typical format for a slice name 80 is shown in FIG. 6. As shown, the slice name (SN) 80 includes a pillar number of the encoded data slice (e.g., one of 1-T), a data segment number (e.g., one of 1-Y), a vault identifier (ID), a data object identifier (ID), and may further include revision level information of the encoded data slices. The slice name functions as at least part of a DSN address for the encoded data slice for storage and retrieval from the DSN memory 22.

As a result of encoding, the computing device 12 or 16 produces a plurality of sets of encoded data slices, which are provided with their respective slice names to the storage units for storage. As shown, the first set of encoded data slices includes EDS 1_1 through EDS 5_1 and the first set of slice names includes SN 1_1 through SN 5_1 and the last set of encoded data slices includes EDS 1_Y through EDS 5_Y and the last set of slice names includes SN 1_Y through SN 5_Y.

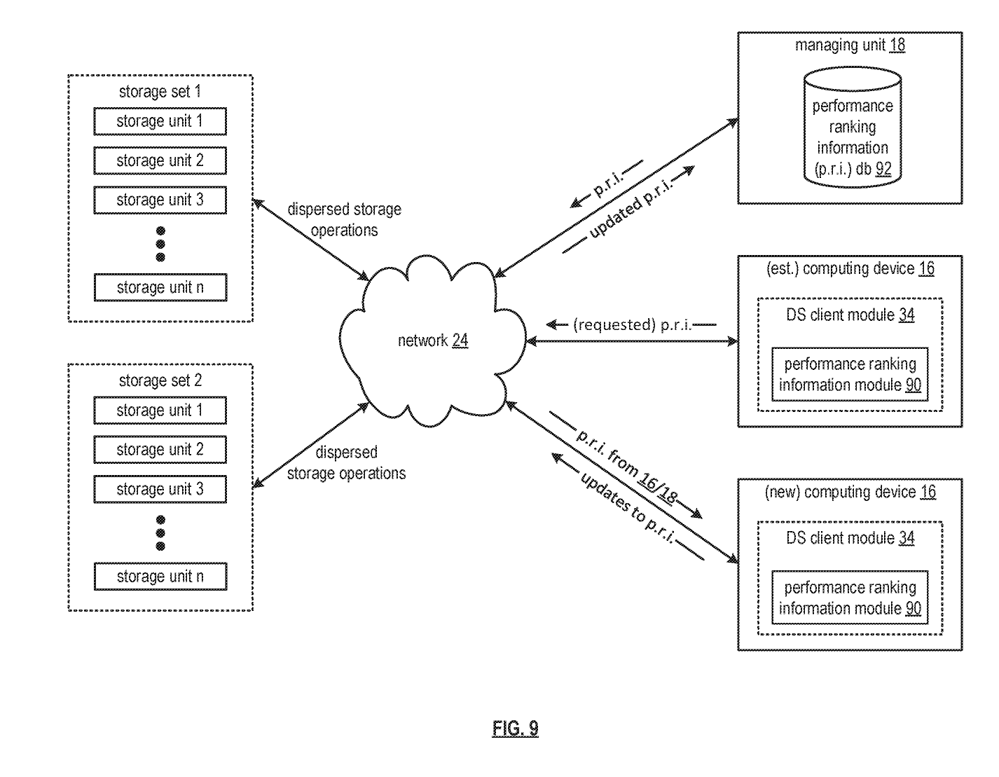

FIG. 7 is a schematic block diagram of an example of dispersed storage error decoding of a data object that was dispersed storage error encoded and stored in the example of FIG. 4. In this example, the computing device 12 or 16 retrieves from the storage units at least the decode threshold number of encoded data slices per data segment. As a specific example, the computing device retrieves a read threshold number of encoded data slices.

In order to recover a data segment from a decode threshold number of encoded data slices, the computing device uses a decoding function as shown in FIG. 8. As shown, the decoding function is essentially an inverse of the encoding function of FIG. 4. The coded matrix includes a decode threshold number of rows (e.g., three in this example) and the decoding matrix in an inversion of the encoding matrix that includes the corresponding rows of the coded matrix. For example, if the coded matrix includes rows 1, 2, and 4, the encoding matrix is reduced to rows 1, 2, and 4, and then inverted to produce the decoding matrix.

FIG. 9 is a schematic block diagram of an embodiment of a dispersed, or distributed, storage network (DSN) including storage unit performance ranking information sharing in accordance with the present disclosure. The illustrated DSN includes storage sets 1-2, the network 24 of FIG. 1, and the computing devices 16 (new and established) and managing unit 18 of FIG. 1. The computing devices 16 include a computing core 26 and DS client module 34 (not separately illustrated) having a performance ranking information module 90 that operates as described below. The storage sets 1-2 each include a set of storage units 1-n. Each storage unit may be implemented utilizing the storage unit 36 depicted in FIG. 1. Each storage set may be interchangeably referred to herein as a set of storage units.

A computing device (such as computing device 12 or 16), upon interacting with many storage units over a period of time, can generate storage unit performance ranking information (also referred to herein as “performance ranking information”) that includes data which indicates, for example, which accessible storage units/storage sets are fastest or otherwise provide relative performance advantages from the perspective of the computing device. However, when a new computing device is added to a DSN and provided access to storage units, or when an established computing device must begin communicating with storage units with which it has not previously interacted, an initial lack of relevant performance ranking information may lead to sub-optimal performance for a period of time until the computing device can establish such information.

As described more fully below, this period of potential sub-optimal performance may be mitigated or even eliminated through sharing of pre-existing performance ranking information with the new computing device. In one example, the new computing device may request and receive such information from one or more established computing devices 16, from a managing unit 18, and/or from a performance ranking information database 92 (e.g., a database maintained in the managing unit 18, in a storage vault, or in another memory location). The storage unit performance ranking information may include, for example, observed performance statistics and characteristics, historical error rates, bandwidth capabilities, average data access latencies, and other information regarding various storage units of the DSN. The storage unit performance ranking information may further include identification and location information relating to the computing device(s) which generated respective information. Various instances of performance ranking information provided to a new computing device 16 may vary substantially depending, for example, on the location of a source computing device. In other examples, performance ranking information may be substantially the same for proximate/co-located source computing devices.

Upon initiation, a new computing device 16 of the DSN may attempt to ascertain performance ranking information for accessible storage units/storage sets. For example, the new computing device 16 may request such information from the closest established computing device and/or an established computing device similar to itself. After receiving responsive performance ranking information, the new computing device 16 can utilize the information to make decisions regarding which storage units to read from or write to, and how to rank or prioritize such storage units, before the new computing device has communicated with them. For example, when recovering data (such as replicated dispersed storage error encoded data) from a storage unit/storage set, a new computing device 16 may first analyze the performance ranking information maintained by a performance ranking information module 90 for purposes of selecting an optimal storage unit/storage set.

Thereafter, the computing device can update and develop its own perspective and ranking statistics, starting from the initial performance ranking information. The computing device may also make its own performance ranking information available (or relay performance ranking information from other computing devices) to other devices of the DSN and/or the performance ranking information database 92. With respect to database operations, the managing unit 18 may be responsible for receiving, gathering, communicating and/or relaying performance ranking information regarding storage units, computing devices and other nodes of the DSN.

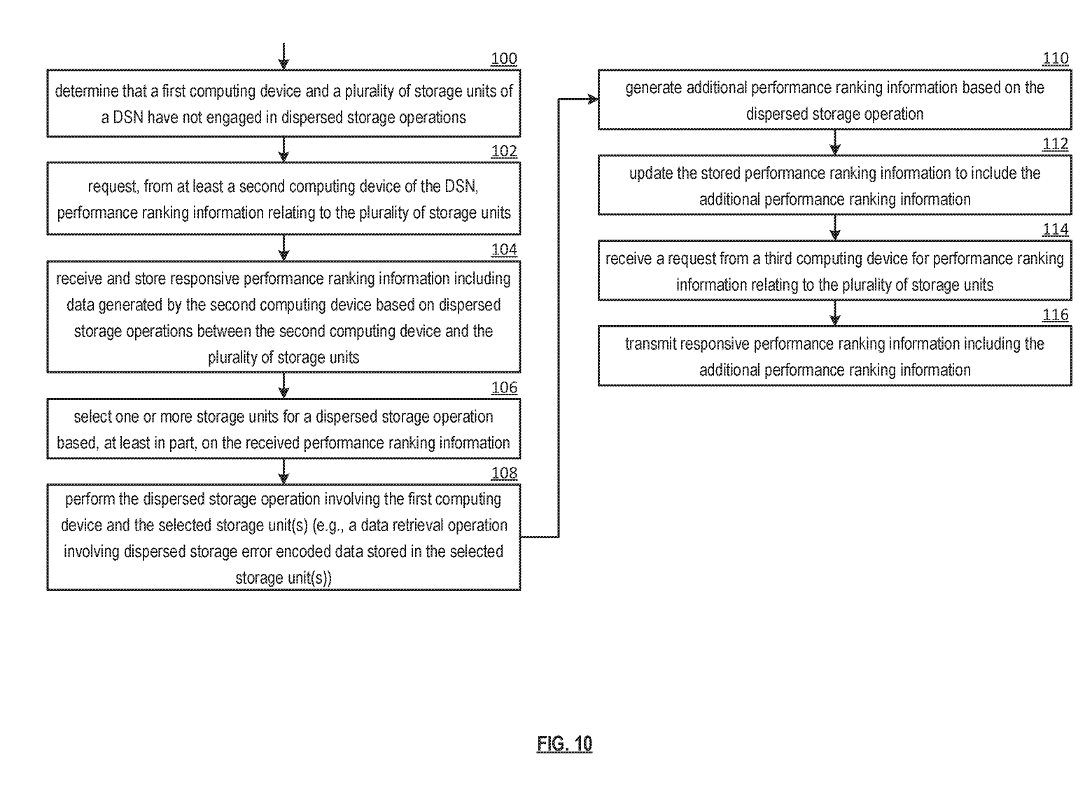

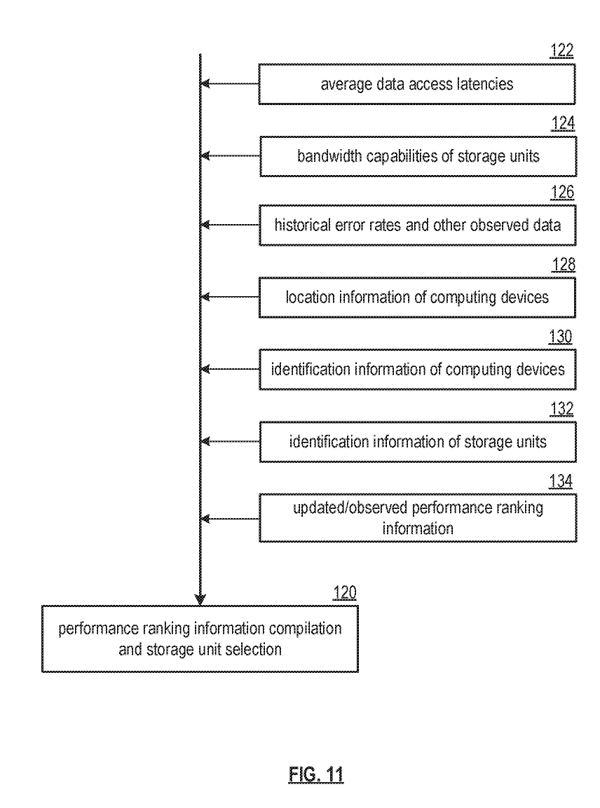

Referring now to FIG. 10, a logic diagram of exemplary use of storage unit performance ranking information in a newly-initialized computing device is shown. In particular, a method is presented for use in conjunction with one or more functions and features described in conjunction with FIGS. 1-9. The method begins at step 100 where a processing module (e.g., of a distributed storage (DS) client module 34 of a computing device 16) determines that the computing device (“first computing device”) and a plurality of storage units of a DSN have not previously engaged in dispersed storage operations, such as when the computing device is a new or newly-initiated device in the DSN. The method continues at step 102 where the processing module initiates a request or solicitation to at least a second computing device (e.g., an established computing device) of the DSN for performance ranking information relating to the plurality of storage units. A solicitation may include an inquiry and/or request or, for example, configuration of a computing device to be available for automated retrieval and/or reception of performance ranking information.

Next, in step 104, the processing module receives and stores responsive performance ranking information. The responsive performance ranking information of this example includes data generated by the second computing device based, at least in part, on dispersed storage operations previously conducted between the second computing device and the plurality of storage units. The method continues at step 106 where the processing module utilizes the received performance ranking information to select one or more storage units for a dispersed storage operation. The dispersed storage operation is then performed, in step 108, and involves the first computing device and the selected storage unit(s). The dispersed storage operation may include, for example, a data retrieval operation for dispersed storage error encoded data stored in the selected storage unit(s).

Next, at step 110, the processing module monitors or otherwise analyzes the dispersed storage operation and then generates additional performance ranking information based on the resulting data. The method continues at step 112 where the processing module updates the previously-stored performance ranking information to include the additional performance ranking information. In this example, at step 114 the processing module may then receive a request from a third computing device of the DSN for performance ranking information relating to the plurality of storage units. In response, at step 116 the processing module transmits or otherwise provides responsive performance ranking information, including the additional performance ranking information, to the third computing device.

FIG. 11 is a logic diagram of an example of generation of storage unit performance ranking information in accordance with the present disclosure. In particular, a method is presented for use in conjunction with one or more functions and features described in conjunction with FIGS. 1-10. Various exemplary performance ranking information are illustrated for use by a computing device in selecting a storage unit and/or set of storage units for performing dispersed storage operations.

In the illustrated example, selection of a storage unit(s) by performance ranking information compilation and storage unit selection modules 120 may be based on one or more types of compiled and/or received performance ranking information including, for example, average data access latencies 122 of storage units (from the perspective of one or more computing devices 16), bandwidth capabilities 124 of storage units, historical error rates and/or other observed data 126 compiled over time. In addition, storage unit selection operations may be based, at least in part, on location information 128 and identification information 130 relating to other computing devices 16 of the DSN, such as a nearby or co-located computing device 16 that provides initial performance ranking information 122-126 with a new computing device. Compiled performance ranking information may further be associated with identification information 132 for relevant storage units. Various other performance ranking information may be utilized, including those referenced above in conjunction with FIGS. 9 and 10. Over time, the performance ranking information compilation and storage unit selection modules 120 may receive or generate updated/observed performance ranking information 134 regarding storage units of the DSN.

The methods described above in conjunction with the computing device and the storage units can alternatively be performed by other modules of the dispersed storage network or by other devices. For example, any combination of a first module, a second module, a third module, a fourth module, etc. of the computing device and the storage units may perform the method described above. In addition, at least one memory section (e.g., a first memory section, a second memory section, a third memory section, a fourth memory section, a fifth memory section, a sixth memory section, etc. of a non-transitory computer readable storage medium) that stores operational instructions can, when executed by one or more processing modules of one or more computing devices and/or by the storage units of the dispersed storage network (DSN), cause the one or more computing devices and/or the storage units to perform any or all of the method steps described above.

As may be used herein, the terms “substantially” and “approximately” provides an industry-accepted tolerance for its corresponding term and/or relativity between items. Such an industry-accepted tolerance ranges from less than one percent to fifty percent. Such relativity between items ranges from a difference of a few percent to magnitude differences. As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may also be used herein, the terms “processing module”, “processing circuit”, “processor”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may be, or further include, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from Figure to Figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, and/or any device that stores digital information. The memory device may be in a form a solid state memory, a hard drive memory, cloud memory, thumb drive, server memory, computing device memory, and/or other physical medium for storing digital information. A computer readable memory/storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method for execution by one or more processing modules of a first computing device of a dispersed storage network (DSN), the DSN having storage resources including a plurality of storage units, the method comprises:
determining that the first computing device and the plurality of storage units have not engaged in dispersed storage operations;
requesting, from at least a second computing device of the DSN, performance ranking information relating to the plurality of storage units; and
receiving responsive performance ranking information, the received performance ranking information including data generated by the at least a second computing device based on dispersed storage operations between the at least a second computing device and the plurality of storage units.

2. The method of claim 1 further comprises:
performing a dispersed storage operation involving the first computing device and one or more of the plurality of storage units;
generating, by the first computing device, additional performance ranking information based on the dispersed storage operation; and
updating the responsive performance ranking information to include the additional performance ranking information.

3. The method of claim 2 further comprises:
receiving, by the first computing device, a request for performance ranking information relating to the plurality of storage units; and
transmitting, by the first computing device, responsive performance ranking information that includes the additional performance ranking information.

4. The method of claim 2, wherein performing a dispersed storage operation involving the first computing device and the one or more of the plurality of storage units includes:
selecting, by the first computing device, the one or more of the plurality of storage units for the dispersed storage operation based at least in part on the received performance ranking information.

5. The method of claim 1, wherein the performance ranking information includes at least one of: historical error rates regarding dispersed storage operations involving the plurality of storage units, bandwidth capabilities of respective ones of the plurality of storage units, or average data access latencies for respective ones of the plurality of storage units.

6. The method of claim 5, wherein the performance ranking information further includes at least one of: location information relating to the at least a second computing device or identification information relating to the at least a second computing device.

7. The method of claim 1, wherein the dispersed storage operations include data retrieval operations involving dispersed storage error encoded data stored in the plurality of storage units.

8. A method for execution by one or more processing modules of a first computing device of a dispersed storage network (DSN), the DSN having storage resources including a plurality of storage units, the method comprises:
initializing the first computing device for participation in the DSN, participation including access to one or more of the plurality of storage units;
querying a database, maintained in a second computing device of the DSN, for performance ranking information relating to the one or more of the plurality of storage units;
receiving responsive performance ranking information from the database, the received performance ranking information including data generated by a third computing device of the DSN based on dispersed storage operations between the third computing device and the one or more of the plurality of storage units; and
storing the received performance ranking information in a memory of the first computing device.

9. The method of claim 8 further comprises:
performing a dispersed storage operation between the first computing device and the one or more of the plurality of storage units;
generating, by the first computing device, additional performance ranking information based on the dispersed storage operation between the first computing device and the one or more of the plurality of storage units; and
updating the stored performance ranking information to include the additional performance ranking information.

10. The method of claim 9 further comprises:
communicating the additional performance ranking information to the second computing device for inclusion in the database.

11. The method of claim 9, wherein performing a dispersed storage operation between the first computing device and the one or more of the plurality of storage units includes:
selecting, by the first computing device, the one or more of the plurality of storage units for the dispersed storage operation based at least in part on the received performance ranking information.

12. The method of claim 8, wherein the performance ranking information includes at least one of: historical error rates regarding dispersed storage operations involving the plurality of storage units, bandwidth capabilities of respective ones of the plurality of storage units, or average data access latencies for respective ones of the plurality of storage units.

13. The method of claim 12, wherein the performance ranking information further includes at least one of: location information relating to the third computing device or identification information for the third computing device.

14. The method of claim 8, wherein the dispersed storage operations include data retrieval operations involving dispersed storage error encoded data stored in the plurality of storage units.

15. A computing device of a group of computing devices of a dispersed storage network (DSN), the DSN having storage resources including a plurality of storage units, the computing device comprises:
an interface;
a local memory; and
a processing module operably coupled to the interface and the local memory, wherein the processing module operates to:
determine that the computing device and the plurality of storage units have not engaged in dispersed storage operations;
issue, via the interface, a request to at least a second computing device of the DSN for performance ranking information relating to the plurality of storage units;
receive, via the interface, responsive performance ranking information, the received performance ranking information including data generated by the at least a second computing device based on dispersed storage operations between the at least a second computing device and the plurality of storage units; and
store the received performance ranking information in the local memory.

16. The computing device of claim 15, wherein the processing module further functions to:
initiate, via the interface, a dispersed storage operation involving the computing device and one or more of the plurality of storage units;
generate additional performance ranking information based on the dispersed storage operation; and
update the stored performance ranking information to include the additional performance ranking information.

17. The computing device of claim 16, wherein the processing module further functions to:
receive, via the interface, a request for performance ranking information relating to the plurality of storage units; and
transmitting, via the interface, responsive performance ranking information that includes the additional performance ranking information.

18. The computing device of claim 15, wherein the processing module further functions to:
initiate the dispersed storage operation involving the computing device and the one or more of the plurality of storage units by selecting the one or more of the plurality of storage units for the dispersed storage operation based at least in part on the received performance ranking information.

19. The computing device of claim 15 wherein the performance ranking information includes at least one of: historical error rates regarding dispersed storage operations involving the plurality of storage units, bandwidth capabilities of respective ones of the plurality of storage units, or average data access latencies for respective ones of the plurality of storage units.

20. The computing device of claim 19, wherein the performance ranking information further includes at least one of: location information relating to the at least a second computing device or identification information relating to the at least a second computing device.
